(19) United States
(12) Patent Application Publication
(10) Pub. No.: US 2025/0244939 A1
(43) Pub. Date: Jul. 31, 2025

(54) DISPLAY CONTROL DEVICE AND CONTROL METHOD

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/022,298

(22) Filed: Jan. 15, 2025

(30) Foreign Application Priority Data
Jan. 29, 2024 (JP) 2024-010869

(51) Int. Cl. G06F 3/14; B60K 35/22; B60K 35/23; B60K 35/29; B60Q 9/00; G06T 11/20; G06T 19/00

(52) U.S. Cl. CPC G06F 3/1423; B60K 35/22; B60K 35/23; B60K 35/29; B60Q 9/00; G06T 11/203; G06T 19/00; B60K 2360/182

(57) ABSTRACT

A display control device includes: a controller that generates a plurality of drawings to coordinate, among a first display device, a second display device, a third display device, and a fourth display device, relative positions of a vehicle and the plurality of drawings on a plurality of display targets; and an outputter that outputs the plurality of drawings generated by the controller to the first display device, the second display device, the third display device, and the fourth display device.

### CROSS REFERENCE TO RELATED APPLICATION

The present application is based on and claims priority of Japanese Patent Application No. 2024-010869 filed on Jan. 29, 2024.

### FIELD

The present disclosure relates to a display control device for controlling a plurality of display devices installed in a vehicle and a control method for such a display control device.

### BACKGROUND

A display control device is known which displays, on a plurality of displays installed in a vehicle, with the same aspect ratio, bird's eye view images of the vehicle and the surroundings of the vehicle which are generated based on results of shooting performed by a plurality of cameras disposed on the front, rear, left, and right sides of the vehicle (see, for example, Patent literature (PTL) 1).

### CITATION LIST

### Patent Literature

PTL 1: Japanese Unexamined Patent Application Publication No. 2019-4397

### SUMMARY

The conventional display control device described above can be improved upon.

In view of this, the present disclosure provides a display control device and a control method capable of improving upon the above related art.

A display control device according to an aspect of the present disclosure is a display control device for controlling a plurality of display devices that: are installed in a vehicle; and display a plurality of drawings to superimpose the plurality of drawings on a plurality of display targets showing surroundings of the vehicle, and the display control device includes: a controller that generates the plurality of drawings to coordinate, among the plurality of display devices, relative positions of the vehicle and the plurality of drawings on the plurality of display targets; and an outputter that outputs the plurality of drawings generated by the controller to the plurality of display devices.

These general or specific aspects may be realized by a system, a method, an integrated circuit, a computer program, or a computer-readable recording medium such as a compact disc-read only memory (CD-ROM), or may be realized by any combination of a system, a method, an integrated circuit, a computer program, and a recording medium.

A display control device or the like according to an aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing the configuration of a display control system in Embodiment 1.

FIG. 2 is a diagram showing display examples of a first display device, a second display device, and a third display device.

FIG. 3 is a diagram showing display examples of the first display device and a fourth display device.

FIG. 4 is a block diagram showing the functional configuration of a controller in a display control device according to Embodiment 1.

FIG. 5 is a diagram showing an example of a virtual three-dimensional space.

FIG. 6 is a flowchart showing the flow of the display control device according to Embodiment 1.

FIG. 7 is a block diagram showing the functional configuration of a controller in a display control device according to Embodiment 2.

FIG. 8 is a block diagram showing the functional configuration of a controller in a display control device according to Embodiment 3.

### DESCRIPTION OF EMBODIMENTS

### Underlying Knowledge Forming Basis of the Present Disclosure

The present inventors have found that the following issue occurs in the technique described in the “Background”.

Disadvantageously, in the conventional display control device described above, when drawings are superimposed on the bird's eye view images and are displayed, a driver feels uncomfortable with differences in how the drawings are viewed among a plurality of displays.

In order to remove the disadvantage as described above, the present inventors conceive display control devices and a control method which will be described below.

### (Technique 1)

A display control device for controlling a plurality of display devices that: are installed in a vehicle; and display a plurality of drawings to superimpose the plurality of drawings on a plurality of display targets showing surroundings of the vehicle, and the display control device includes: a controller that generates the plurality of drawings to coordinate, among the plurality of display devices, relative positions of the vehicle and the plurality of drawings on the plurality of display targets; and an outputter that outputs the plurality of drawings generated by the controller to the plurality of display devices.

In technique 1, the controller generates the plurality of drawings to coordinate, among the plurality of display devices, relative positions of the vehicle and the plurality of drawings on the plurality of display targets. In this way, it is possible to reduce an uncomfortable feeling caused by differences in how the plurality of drawings are viewed among the plurality of display devices.

### (Technique 2)

In the display control device described in technique 1, the controller includes: a generator that draws, in a virtual three-dimensional space where the vehicle and the surroundings of the vehicle are virtually shown, a virtual drawing that virtually represents the plurality of drawings to generate target information indicating coordinates of the virtual drawing in the virtual three-dimensional space; and a plurality of drawers that generate, based on the target information generated by the generator, the plurality of drawings.

In technique 2, it is possible to easily generate the plurality of drawings based on the target information generated by utilization of the virtual three-dimensional space.

### (Technique 3)

In the display control device described in technique 1, the controller includes: a plurality of drawers that generate, based on target information indicating coordinates of the plurality of drawings, the plurality of drawings to coordinate, among the plurality of display devices, the relative positions of the vehicle and the plurality of drawings on the plurality of display targets, and each of the plurality of drawers shares the target information with one or more of the plurality of drawers other than the drawer.

In technique 3, it is possible to easily generate the plurality of drawings based on the target information shared between the plurality of drawers.

### (Technique 4)

In the display control device described in technique 1, the controller includes: a plurality of drawers that generate, based on target information indicating coordinates of the plurality of drawings, the plurality of drawings to coordinate, among the plurality of display devices, the relative positions of the vehicle and the plurality of drawings on the plurality of display targets, and a specific drawer of the plurality of drawers generates the target information, and distributes the target information generated to one or more of the plurality of drawers other than the specific drawer.

In technique 4, it is possible to easily generate the plurality of drawings based on the target information distributed from the specific drawer to the one or more of the plurality of drawers other than the specific drawer.

### (Technique 5)

In the display control device described in any one of techniques 1 to 4, the controller further coordinates, among the plurality of display devices, at least one of a color, a size, or an angle of the plurality of drawings on the plurality of display targets.

In technique 5, it is possible to more effectively reduce an uncomfortable feeling caused by differences in how the plurality of drawings are viewed among the plurality of display devices.

### (Technique 6)

In the display control device described in any one of techniques 1 to 5, the plurality of display devices include an image display device that: displays, as one of the plurality of display targets, an image showing the surroundings of the vehicle; and displays a drawing among the plurality of drawings to superimpose the drawing on the image.

In technique 6, when the plurality of display devices include the image display device, it is possible to reduce an uncomfortable feeling caused by differences in how the plurality of drawings are viewed among the plurality of display devices.

### (Technique 7)

In the display control device described in technique 6, the image display device is one of a center display, an electronic mirror, or a head-up display.

In technique 7, the image display device can be formed with one of the vehicle center display, the electronic mirror, and the head-up display.

### (Technique 8)

In the display control device described in any one of techniques 1 to 7, the plurality of display devices include a vehicle lighting device that emits light to a road surface around the vehicle to form, as one of the plurality of drawings, an illumination pattern on the road surface, the road surface serving as one of the plurality of display targets.

In technique 8, when the plurality of display devices include the vehicle lighting device, it is possible to reduce an uncomfortable feeling caused by differences in how the plurality of drawings are viewed among the plurality of display devices.

### (Technique 9)

In the display control device described in any one of techniques 1 to 8, the plurality of display devices display the plurality of drawings from different viewpoints.

In technique 9, even when the viewpoints of the plurality of display devices are different from each other, it is possible to reduce an uncomfortable feeling caused by differences in how the plurality of drawings are viewed among the plurality of display devices.

### (Technique 10)

A control method is performed by a display control device to control a plurality of display devices that: are installed in a vehicle; and display a plurality of drawings to superimpose the plurality of drawings on a plurality of display targets showing surroundings of the vehicle, and the control method includes: (a) generating the plurality of drawings to coordinate, among the plurality of display devices, relative positions of the vehicle and the plurality of drawings on the plurality of display targets; and (b) outputting, to the plurality of display devices, the plurality of drawings generated in (a).

In technique 10, the plurality of drawings are generated to coordinate, among the plurality of display devices, relative positions of the vehicle and the plurality of drawings on the plurality of display targets. In this way, it is possible to reduce an uncomfortable feeling caused by differences in how the plurality of drawings are viewed among the plurality of display devices.

These general or specific aspects may be realized by a system, a method, an integrated circuit, a computer program, or a computer-readable recording medium such as a CD-ROM, or may be realized by any combination of a system, a method, an integrated circuit, a computer program, and a recording medium.

Embodiments will be specifically described below with reference to drawings.

Each of the embodiments described below indicates a general or specific example. Numerical values, shapes, materials, constituent elements, the arrangement and connection of the constituent elements, steps, the order of the steps, and the like shown in the following embodiments are examples, and are not intended to limit the present disclosure. Among the constituent elements in the following embodiments, constituent elements which are not recited in the independent claims indicating the highest level of concept are described as optional constituent elements.

### Embodiment 1

### [1-1. Configuration of Display Control System]

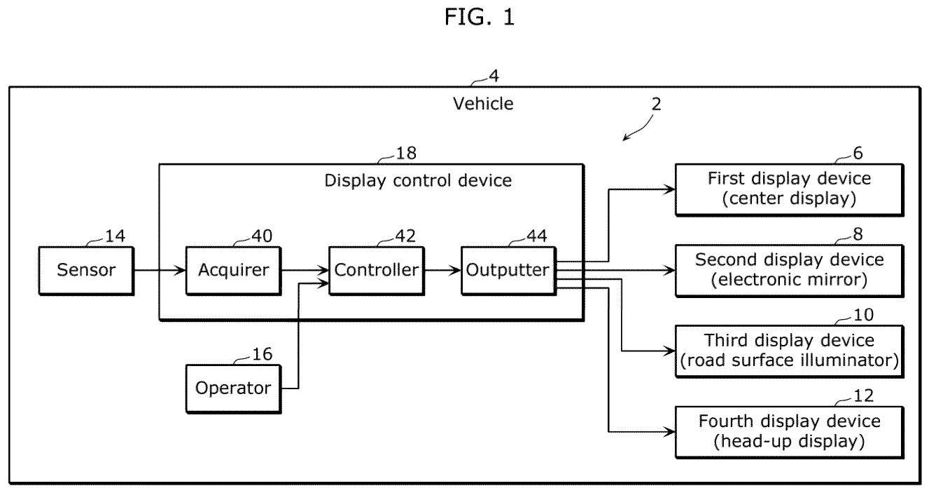

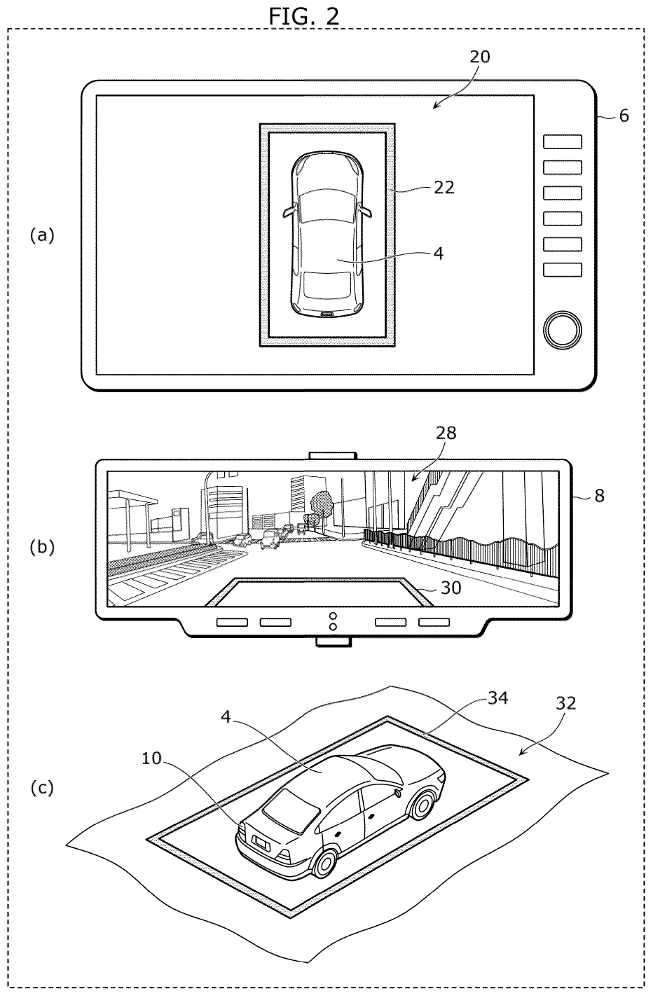

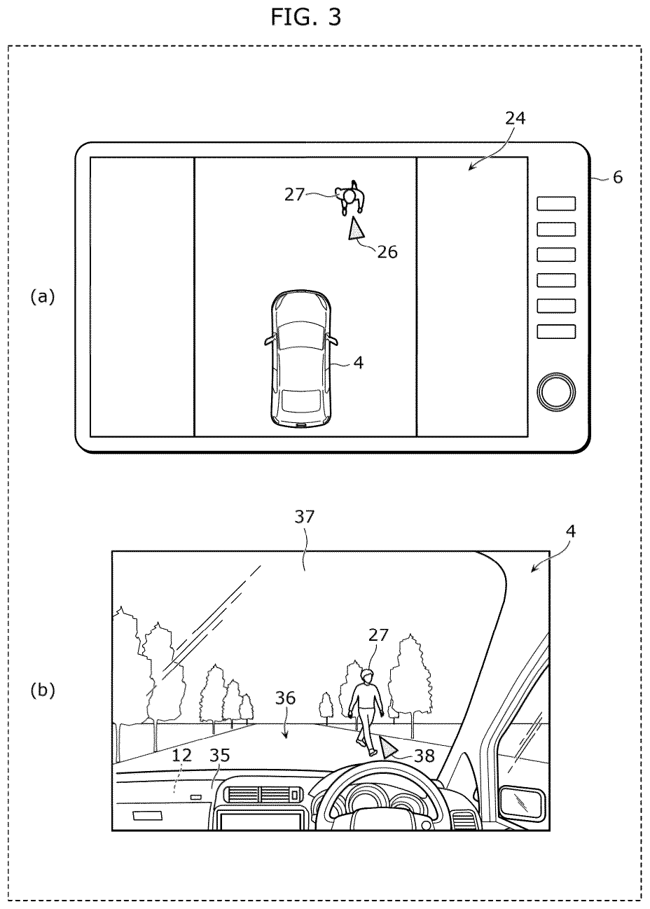

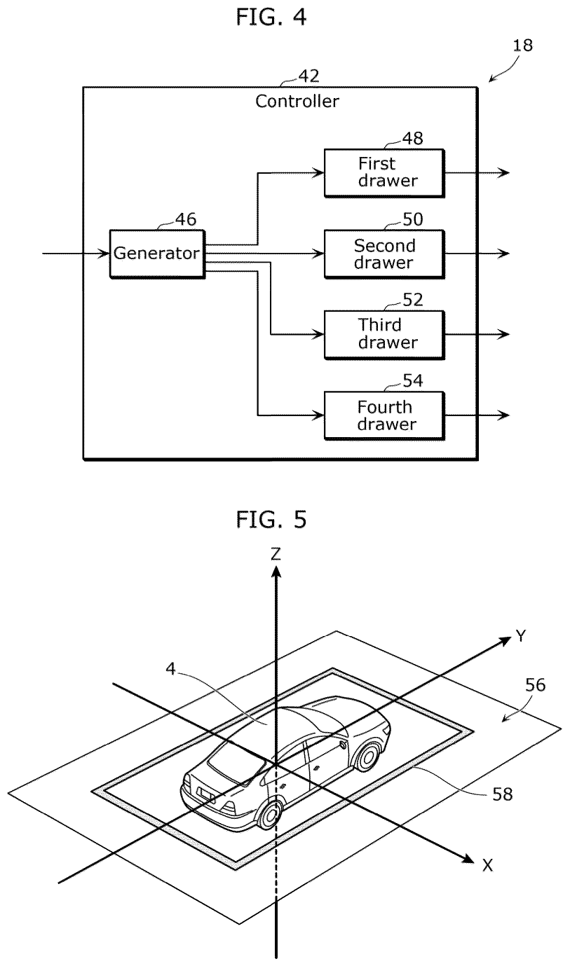

The configuration of display control system 2 in Embodiment 1 will first be described with reference to FIGS. 1 to 5. FIG. 1 is a block diagram showing the configuration of display control system 2 in Embodiment 1. FIG. 2 is a diagram showing display examples of first display device 6, second display device 8, and third display device 10. FIG. 3 is a diagram showing display examples of first display device 6 and fourth display device 12. FIG. 4 is a block diagram showing the functional configuration of controller 42 in display control device 18 according to Embodiment 1. FIG. 5 is a diagram showing an example of virtual three-dimensional space 56.

As shown in FIG. 1, for example, display control system 2 is installed in vehicle 4 such as an automobile. Display control system 2 includes first display device 6, second display device 8, third display device 10, fourth display device 12, sensor 14, operator 16, and display control device 18.

First display device 6 is an image display device installed in vehicle 4, and is specifically a center display which is disposed in the center of an instrument panel inside vehicle 4.

As shown in part (a) in FIG. 2, first display device 6 displays, for example, first display target 20 which is a bird's eye view image (so-called around-view monitor image) showing vehicle 4 and the surroundings of vehicle 4, superimposes first drawing 22 which is a rectangular frame surrounding vehicle 4 on first display target 20, and displays first drawing 22 superimposed thereon. In other words, first display device 6 displays first drawing 22 from a bird's eye viewpoint looking down on vehicle 4 from above vehicle 4. First display target 20 and first drawing 22 are displayed, for example, when a driver shifts a shift lever to a R (reverse) range during parking of vehicle 4. First drawing 22 is displayed to assist the parking of vehicle 4 performed by the driver.

As shown in part (a) in FIG. 3, first display device 6 displays, for example, first display target 24 which is a bird's eye view image showing vehicle 4 and the surroundings of vehicle 4, superimposes first drawing 26 which is a triangular highlighted image for highlighting pedestrian 27 present in front of vehicle 4 on first display target 24, and displays first drawing 26 superimposed thereon. In other words, first display device 6 displays first drawing 26 from a bird's eye viewpoint looking down on vehicle 4 from directly above vehicle 4. First display target 24 and first drawing 26 are displayed, for example, when the driver operates a combination switch lever. First drawing 26 is displayed to alert the driver to the presence of pedestrian 27.

First display targets 20 and 24 described above are generated by combining a front image showing the front of vehicle 4 shot by a camera disposed at a front portion of vehicle 4, a rear image showing the rear of vehicle 4 shot by a camera disposed at a rear portion of vehicle 4, a left side image showing the left side of vehicle 4 shot by a camera disposed at a left side portion of vehicle 4, and a right side image showing the right side of vehicle 4 shot by a camera disposed at a right side portion of vehicle 4. Here, in the present specification, “front”, “rear”, “left”, and “right” respectively mean the front, the rear, the left, and the right when viewed by the driver who sits in the driver's seat of vehicle 4 while facing forward.

Second display device 8 is an image display device installed in vehicle 4, and is specifically an electronic inner mirror disposed inside vehicle 4. As shown in part (b) in FIG. 2, second display device 8 displays, for example, second display target 28 which is a rear image showing the rear of vehicle 4, superimposes second drawing 30 which is a rectangular frame surrounding vehicle 4 on second display target 28, and displays second drawing 30 superimposed thereon. Second display target 28 and second drawing 30 are displayed, for example, when the driver shifts the shift lever to the R range during parking of vehicle 4. Second display target 28 is the rear image shot by the camera disposed at the rear portion of vehicle 4. In other words, second display device 8 displays second drawing 30 from a viewpoint looking rearward from the rear portion of vehicle 4. Second drawing 30 is displayed to assist the parking of vehicle 4 performed by the driver.

Third display device 10 is a vehicle lighting device installed in vehicle 4, and is specifically a road surface illuminator disposed outside vehicle 4. As shown in part (c) in FIG. 2, third display device 10 emits light to third display target 32 which is a road surface around vehicle 4 to form third drawing 34 which is a rectangular frame (illumination pattern) surrounding vehicle 4 on third display target 32 (that is, to superimpose third drawing 34 on third display target 32 and display third drawing 34). In other words, third display device 10 forms third drawing 34 from a bird's eye viewpoint looking obliquely down from the driver on the road surface. Third drawing 34 is formed on third display target 32, for example, when the driver shifts the shift lever to the R range during parking of vehicle 4. Third drawing 34 is displayed to assist the parking of vehicle 4 performed by the driver.

Fourth display device 12 is an image display device installed in vehicle 4, and is specifically a head-up display (HUD) disposed in instrument panel 35 inside vehicle 4. As shown in part (b) in FIG. 3, fourth display device 12 superimposes fourth drawing 38 which is a triangular highlighted image (virtual image) for highlighting pedestrian 27 present in front of vehicle 4 on fourth display target 36, and displays fourth drawing 38 superimposed thereon. In other words, fourth display device 12 displays fourth drawing 38 from a viewpoint looking forward from the driver in vehicle 4. In this way, the driver can view fourth drawing 38 superimposed on fourth display target 36 in front of windshield 37 through a display region on the driver's seat side of windshield 37 of vehicle 4. Fourth display target 36 and fourth drawing 38 are displayed, for example, when the driver operates the combination switch lever. Fourth drawing 38 is displayed to alert the driver to the presence of pedestrian 27.

As described above, first display device 6, second display device 8, third display device 10, and fourth display device 12 display first drawing 22 (26), second drawing 30, third drawing 34, and fourth drawing 38 from different viewpoints.

Sensor 14 is installed in vehicle 4 to detect the surrounding conditions of vehicle 4. The surrounding conditions of vehicle 4 mean, for example, a pedestrian present around vehicle 4, objects such as another vehicle and an obstacle, the positions of the objects, and the like. Examples of sensor 14 include various types of sensors such as a camera (image sensor), a sonar sensor, a radar, and a light detection and ranging (LIDAR) sensor.

Operator 16 is an interface which is installed in vehicle 4 to receive an operation performed by the driver. Examples of operator 16 include a shift lever, a combination switch lever, input buttons of instrument panel 35, and the like.

Display control device 18 is, for example, an electronic control unit (ECU) which is installed in vehicle 4. Display control device 18 includes acquirer 40, controller 42, and outputter 44. Acquirer 40 acquires results of detection from sensor 14, and outputs the acquired results of detection to controller 42.

Controller 42 controls first display device 6, second display device 8, third display device 10, and fourth display device 12. As shown in FIG. 4, controller 42 includes generator 46, first drawer 48, second drawer 50, third drawer 52, and fourth drawer 54.

When operator 16 receives an operation of shifting the shift lever to the R range performed by the driver, generator 46 draws, as shown in FIG. 5, in virtual three-dimensional space 56 where vehicle 4 and the surroundings of vehicle 4 are virtually shown, virtual drawing 58 which virtually represents first drawing 22, second drawing 30, and third drawing 34. In this way, generator 46 generates target information indicating coordinates (X, Y, Z) of virtual drawing 58 in virtual three-dimensional space 56.

When operator 16 receives the operation of shifting the shift lever to the R range performed by the driver, first drawer 48 generates first drawing 22 based on the results of detection from acquirer 40 and the target information generated by generator 46.

When operator 16 receives the operation of shifting the shift lever to the R range performed by the driver, second drawer 50 generates second drawing 30 based on the results of detection from acquirer 40 and the target information generated by generator 46.

When operator 16 receives the operation of shifting the shift lever to the R range performed by the driver, third drawer 52 generates third drawing 34 based on the results of detection from acquirer 40 and the target information generated by generator 46.

In other words, first drawer 48, second drawer 50, and third drawer 52 generate first drawing 22, second drawing 30, and third drawing 34 to coordinate (match), among first display device 6, second display device 8, and third display device 10, (i) relative positions of vehicle 4 and first drawing 22 on first display target 20, (ii) relative positions of vehicle 4 and second drawing 30 on second display target 28, and (iii) relative positions of vehicle 4 and third drawing 34 on third display target 32.

First drawer 48, second drawer 50, and third drawer 52 may generate first drawing 22, second drawing 30, and third drawing 34 to coordinate, among first display device 6, second display device 8, and third display device 10, in addition to the relative positions described above, (i) at least one of the color, the size, or the angle of first drawing 22 on first display target 20, (ii) at least one of the color, the size, or the angle of second drawing 30 on second display target 28, and (iii) at least one of the color, the size, or the angle of third drawing 34 on third display target 32. In this way, even when the viewpoints of first display device 6, second display device 8, and third display device 10 are different from each other, it is possible to reduce an uncomfortable feeling caused by differences in how the color, the size, and the angle of first drawing 22, second drawing 30, and third drawing 34 are viewed.

When operator 16 receives an operation of operating the combination switch lever performed by the driver, generator 46 draws, in the virtual three-dimensional space where vehicle 4 and the surroundings of vehicle 4 are virtually shown, a virtual drawing that virtually represents first drawing 26 and fourth drawing 38 though not shown in the figure. In this way, generator 46 generates the target information indicating coordinates (X, Y, Z) of the virtual drawing in the virtual three-dimensional space.

When operator 16 receives the operation of operating the combination switch lever performed by the driver, first drawer 48 generates first drawing 26 based on the results of detection from acquirer 40 and the target information generated by generator 46.

When operator 16 receives the operation of operating the combination switch lever performed by the driver, fourth drawer 54 generates fourth drawing 38 based on the results of detection from acquirer 40 and the target information generated by generator 46.

In other words, first drawer 48 and fourth drawer 54 generate first drawing 26 and fourth drawing 38 to coordinate, between first display device 6 and fourth display device 12, (i) relative positions of vehicle 4 and first drawing 26 on first display target 24 and (ii) relative positions of vehicle 4 and fourth drawing 38 on fourth display target 36.

First drawer 48 and fourth drawer 54 may generate first drawing 26 and fourth drawing 38 to coordinate, between first display device 6 and fourth display device 12, in addition to the relative positions described above, (i) at least one of the color, the size, or the angle of first drawing 26 on first display target 24 and (ii) at least one of the color, the size, or the angle of fourth drawing 38 on fourth display target 36. In this way, even when the viewpoints of first display device 6 and fourth display device 12 are different from each other, it is possible to reduce an uncomfortable feeling caused by differences in how the color, the size, and the angle of first drawing 26 and fourth drawing 38 are viewed.

With reference back to FIG. 1, outputter 44 outputs first drawing 22 (26), second drawing 30, third drawing 34, and fourth drawing 38 generated by controller 42 to first display device 6, second display device 8, third display device 10, and fourth display device 12.

In this way, for example, when operator 16 receives the operation of shifting the shift lever to the R range performed by the driver, as shown in parts (a), (b), and (c) in FIG. 2, (i) first display device 6 superimposes first drawing 22 on first display target 20, and displays first drawing 22 superimposed thereon, (ii) second display device 8 superimposes second drawing 30 on second display target 28, and displays second drawing 30 superimposed thereon, and (iii) third display device 10 superimposes third drawing 34 on third display target 32, and displays third drawing 34 superimposed thereon.

Here, as shown in parts (a), (b), and (c) in FIG. 2, relative positions of vehicle 4 and first drawing 22 on first display target 20, relative positions of vehicle 4 and second drawing 30 on second display target 28, and relative positions of vehicle 4 and third drawing 34 on third display target 32 are matched.

For example, when operator 16 receives the operation of operating the combination switch lever performed by the driver, as shown in parts (a) and (b) in FIG. 3, (i) first display device 6 superimposes first drawing 26 on first display target 24, and displays first drawing 26 superimposed thereon, and (ii) fourth display device 12 superimposes fourth drawing 38 on fourth display target 36, and displays fourth drawing 38 superimposed thereon.

In this way, as shown in parts (a) and (b) in FIG. 3, relative positions of vehicle 4 and first drawing 26 on first display target 24 and relative positions of vehicle 4 and fourth drawing 38 on fourth display target 36 are matched.

First drawer 48, second drawer 50, third drawer 52, and fourth drawer 54 may generate first drawing 22, second drawing 30, third drawing 34, and fourth drawing 38 to coordinate, among first display device 6, second display device 8, third display device 10, and fourth display device 12, (i) relative positions of vehicle 4 and first drawing 22 on first display target 20, (ii) relative positions of vehicle 4 and second drawing 30 on second display target 28, (iii) relative positions of vehicle 4 and third drawing 34 on third display target 32, and (iv) relative positions of vehicle 4 and fourth drawing 38 on fourth display target 36.

### [1-2. Operation of Display Control Device]

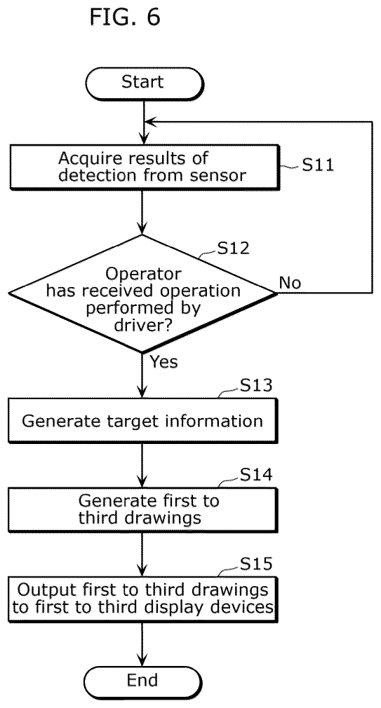

An operation of display control device 18 according to Embodiment 1 will then be described with reference to FIG. 6. FIG. 6 is a flowchart showing the flow of display control device 18 according to Embodiment 1.

An operation of display control device 18 when operator 16 receives the operation of shifting the shift lever to the R range performed by the driver will be described below. As shown in FIG. 6, acquirer 40 first acquires results of detection from sensor 14 (S11). Then, when operator 16 has not received the operation performed by the driver (no in S12), the processing returns to step S11 described above.

On the other hand, when operator 16 has received the operation performed by the driver (yes in S12), generator 46 in controller 42 draws virtual drawing 58 in virtual three-dimensional space 56, and generates target information indicating the coordinates of virtual drawing 58 in virtual three-dimensional space 56 (S13).

Then, first drawer 48, second drawer 50, and third drawer 52 in controller 42 generate first drawing 22, second drawing 30, and third drawing 34 based on the results of detection from acquirer 40 and the target information generated by generator 46 (S14).

Here, first drawer 48, second drawer 50, and third drawer 52 generate first drawing 22, second drawing 30, and third drawing 34 to coordinate, among first display device 6, second display device 8, and third display device 10, (i) relative positions of vehicle 4 and first drawing 22 on first display target 20, (ii) relative positions of vehicle 4 and second drawing 30 on second display target 28, and (iii) relative positions of vehicle 4 and third drawing 34 on third display target 32.

Then, outputter 44 outputs first drawing 22, second drawing 30, and third drawing 34 generated by controller 42 to first display device 6, second display device 8, and third display device 10 (S15).

An operation of display control device 18 when operator 16 receives the operation of operating the combination switch lever performed by the driver is the same as described above, and thus description thereof is omitted.

### [1-3. Effects]

As described above, for example, when operator 16 receives the operation of shifting the shift lever to the R range performed by the driver, as shown in parts (a), (b), and (c) in FIG. 2, (i) first display device 6 superimposes first drawing 22 on first display target 20, and displays first drawing 22 superimposed thereon, (ii) second display device 8 superimposes second drawing 30 on second display target 28, and displays second drawing 30 superimposed thereon, and (iii) third display device 10 superimposes third drawing 34 on third display target 32, and displays third drawing 34 superimposed thereon.

Here, (i) relative positions of vehicle 4 and first drawing 22 on first display target 20, (ii) relative positions of vehicle 4 and second drawing 30 on second display target 28, and (iii) relative positions of vehicle 4 and third drawing 34 on third display target 32 are coordinated.

In this way, for example, it is possible to reduce an uncomfortable feeling caused by differences in how (i) first drawing 22 which is a frame viewed from directly above vehicle 4, (ii) second drawing 30 which is a frame viewed obliquely downward from a rear portion of vehicle 4, and (iii) third drawing 34 which is a frame viewed obliquely downward from the viewpoint of the driver who sits in the driver's seat are viewed (such as the feeling of distance). In other words, even when the viewpoints of first display device 6, second display device 8, and third display device 10 are different from each other, it is possible to reduce an uncomfortable feeling caused by differences in how the relative positions described above are viewed.

For example, when operator 16 receives the operation of operating the combination switch lever performed by the driver, as shown in parts (a) and (b) in FIG. 3, (i) first display device 6 superimposes first drawing 26 on first display target 24, and displays first drawing 26 superimposed thereon, and (ii) fourth display device 12 superimposes fourth drawing 38 on fourth display target 36, and displays fourth drawing 38 superimposed thereon.

Here, (i) relative positions of vehicle 4 and first drawing 26 on first display target 24 and (ii) relative positions of vehicle 4 and fourth drawing 38 on fourth display target 36 are coordinated between first display device 6 and fourth display device 12.

In this way, for example, it is possible to reduce an uncomfortable feeling caused by differences in how (i) first drawing 26 which is a triangular highlighted image viewed from directly above vehicle 4 and (ii) fourth drawing 38 which is a triangular highlighted image viewed obliquely downward from the viewpoint of the driver who sits in the driver's seat are viewed (such as the feeling of distance) between first display device 6 and fourth display device 12 when driver drives vehicle 4. In other words, even when the viewpoints of first display device 6 and fourth display device 12 are different from each other, it is possible to reduce an uncomfortable feeling caused by differences in how the relative positions described above are viewed.

### Embodiment 2

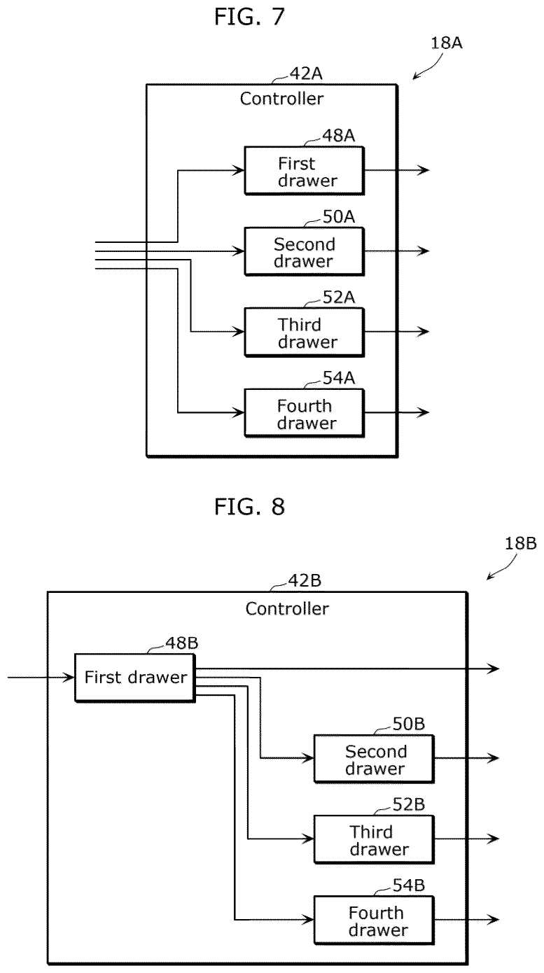

The functional configuration of controller 42A in display control device 18A according to Embodiment 2 will be described with reference to FIG. 7. FIG. 7 is a block diagram showing the functional configuration of controller 42A in display control device 18A according to Embodiment 2. In the present embodiment, the same constituent elements as in Embodiment 1 described above are identified with the same symbols, and description thereof is omitted.

As shown in FIG. 7, controller 42A in display control device 18A includes first drawer 48A, second drawer 50A, third drawer 52A, and fourth drawer 54A.

Each of first drawer 48A, second drawer 50A, third drawer 52A, and fourth drawer 54A shares target information indicating coordinates of a first drawing, a second drawing, a third drawing, and a fourth drawing with three drawers other than the drawer described above. The target information may be a data table which indicates a correspondence between the first drawing, the second drawing, the third drawing, and the fourth drawing and the coordinates thereof.

In this way, first drawer 48A, second drawer 50A, third drawer 52A, and fourth drawer 54A generate the first drawing, the second drawing, the third drawing, and the fourth drawing to coordinate, based on the shared target information, among first display device 6, second display device 8, third display device 10, and fourth display device 12 (see FIG. 1), (i) relative positions of vehicle 4 (see FIG. 1) and the first drawing on a first display target, (ii) relative positions of vehicle 4 and the second drawing on a second display target, (iii) relative positions of vehicle 4 and the third drawing on a third display target, and (iv) relative positions of vehicle 4 and the fourth drawing on a fourth display target.

Hence, in the present embodiment, the same effects as in Embodiment 1 described above can also be obtained.

### Embodiment 3

The functional configuration of controller 42B in display control device 18B according to Embodiment 3 will be described with reference to FIG. 8. FIG. 8 is a block diagram showing the functional configuration of controller 42B in display control device 18B according to Embodiment 3. In the present embodiment, the same constituent elements as in Embodiment 1 described above are identified with the same symbols, and description thereof is omitted.

As shown in FIG. 8, controller 42B in display control device 18B includes first drawer 48B, second drawer 50B, third drawer 52B, and fourth drawer 54B.

First drawer 48B generates target information indicating coordinates of a first drawing, a second drawing, a third drawing, and a fourth drawing. The target information may be a data table which indicates a correspondence between the first drawing, the second drawing, the third drawing, and the fourth drawing and the coordinates thereof. First drawer 48B distributes the generated target information to second drawer 50B, third drawer 52B, and fourth drawer 54B.

In this way, first drawer 48B, second drawer 50B, third drawer 52B, and fourth drawer 54B generate the first drawing, the second drawing, the third drawing, and the fourth drawing to coordinate, based on the target information, among first display device 6, second display device 8, third display device 10, and fourth display device 12 (see FIG. 1), (i) relative positions of vehicle 4 (see FIG. 1) and the first drawing on a first display target, (ii) relative positions of vehicle 4 and the second drawing on a second display target, (iii) relative positions of vehicle 4 and the third drawing on a third display target, and (iv) relative positions of vehicle 4 and the fourth drawing on a fourth display target.

Hence, in the present embodiment, the same effects as in Embodiment 1 described above can also be obtained.

### Other Variations

Although the display control device according to one or a plurality of aspects and the control method therefor have been described above based on the above embodiments, the present disclosure is not limited to the above embodiments. Embodiments obtained by performing various variations conceived by those skilled in the art on the above embodiments and embodiments formed by combining constituent elements in different embodiments may be included in the scope of one or a plurality of aspects as long as they do not depart from the spirit of the present disclosure.

For example, although in each of the embodiments described above, first drawing 22, second drawing 30, and third drawing 34 are the frames, and first drawing 26 and fourth drawing 38 are the triangular highlighted images, the present disclosure is not limited to this configuration. Each of first drawing 22, second drawing 30, third drawing 34, and fourth drawing 38 may be, for example, (a) a rear guide line when vehicle 4 moves backward, (b) a vehicle width guide line, (c) an arrow line for highlighting a pedestrian, (d) an icon indicating a pedestrian, another vehicle, or the like, (e) a pedestrian crossing, (f) a sign, or the like.

For example, although in each of the embodiments described above, a case where the four output devices (first display device 6, second display device 8, third display device 10, and fourth display device 12) are installed in vehicle 4 has been described, the present disclosure is not limited to this case, and at least two output devices may be installed in vehicle 4.

In each of the embodiments described above, constituent elements may be formed by dedicated hardware, or may be realized by executing computer programs suitable for the constituent elements. A program executor such as a central processing unit (CPU) or a processor may read and execute computer programs recorded in a recording medium such as a hard disk or a semiconductor memory to realize the constituent elements.

A processor such as a CPU may execute computer programs to realize a part or all of the functions of the display control device according to each of the embodiments described above.

A part or all of the constituent elements of each of the devices described above may be formed with an IC card or a single module which is removable with respect to the device. The IC card or the module described above is a computer system which includes a microprocessor, a ROM, a RAM, and the like. The IC card or the module may include the ultra-multifunctional LSI described above. The microprocessor is operated according to computer programs, and thus the IC card or the module achieves its function. The IC card or the module may be tamper-resistant.

The present disclosure may be the methods described above. The present disclosure may be computer programs which cause a computer to realize these methods, or may be digital signals which include the computer programs. The present disclosure may be a non-transitory computer-readable recording medium such as a flexible disk, a hard disk, a CD-ROM, an MO, a DVD, a DVD-ROM, a DVD-RAM, a Blu-ray (registered trademark) disc (BD), or a semiconductor memory in which the computer programs or the digital signals are recorded. The present disclosure may be the digital signals recorded in one of these recording media. The present disclosure may be a unit which transfers the computer programs or the digital signals via a telecommunication line, a wireless or wired communication line, a network such as the Internet, data broadcasting, or the like. The present disclosure may be a computer system including a microprocessor and a memory in which the memory stores the computer programs, and the microprocessor is operated according to the computer programs. The present disclosure may be another independent computer system which is performed by recording the computer programs or the digital signals in the recording medium and transferring them or by transferring the computer programs or the digital signals via the network described above or the like.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2024-010869 filed on Jan. 29, 2024.

### INDUSTRIAL APPLICABILITY

The present disclosure is applicable to, for example, a display control device and the like for controlling a plurality of display devices installed in a vehicle.

1. A display control device for controlling a plurality of display devices that:
are installed in a vehicle; and
display a plurality of drawings to superimpose the plurality of drawings on a plurality of display targets showing surroundings of the vehicle, the display control device comprising:
a controller that generates the plurality of drawings to coordinate, among the plurality of display devices, relative positions of the vehicle and the plurality of drawings on the plurality of display targets; and
an outputter that outputs the plurality of drawings generated by the controller to the plurality of display devices.

2. The display control device according to claim 1,
wherein the controller includes:
a generator that draws, in a virtual three-dimensional space where the vehicle and the surroundings of the vehicle are virtually shown, a virtual drawing that virtually represents the plurality of drawings to generate target information indicating coordinates of the virtual drawing in the virtual three-dimensional space; and
a plurality of drawers that generate, based on the target information generated by the generator, the plurality of drawings.

3. The display control device according to claim 1,
wherein the controller includes:
a plurality of drawers that generate, based on target information indicating coordinates of the plurality of drawings, the plurality of drawings to coordinate, among the plurality of display devices, the relative positions of the vehicle and the plurality of drawings on the plurality of display targets, and
each of the plurality of drawers shares the target information with one or more of the plurality of drawers other than the drawer.

4. The display control device according to claim 1,
wherein the controller includes:
a plurality of drawers that generate, based on target information indicating coordinates of the plurality of drawings, the plurality of drawings to coordinate, among the plurality of display devices, the relative positions of the vehicle and the plurality of drawings on the plurality of display targets, and
a specific drawer of the plurality of drawers generates the target information, and distributes the target information generated to one or more of the plurality of drawers other than the specific drawer.

5. The display control device according to claim 1,
wherein the controller further coordinates, among the plurality of display devices, at least one of a color, a size, or an angle of the plurality of drawings on the plurality of display targets.

6. The display control device according to claim 1,
wherein the plurality of display devices include an image display device that:
displays, as one of the plurality of display targets, an image showing the surroundings of the vehicle; and
displays a drawing among the plurality of drawings to superimpose the drawing on the image.

7. The display control device according to claim 6,
wherein the image display device is one of a center display, an electronic mirror, or a head-up display.

8. The display control device according to claim 1,
wherein the plurality of display devices include a vehicle lighting device that emits light to a road surface around the vehicle to form, as one of the plurality of drawings, an illumination pattern on the road surface, the road surface serving as one of the plurality of display targets.

9. The display control device according to claim 1,
wherein the plurality of display devices display the plurality of drawings from different viewpoints.

10. A control method that is performed by a display control device to control a plurality of display devices that:
are installed in a vehicle; and
display a plurality of drawings to superimpose the plurality of drawings on a plurality of display targets showing surroundings of the vehicle, the control method comprising:
(a) generating the plurality of drawings to coordinate, among the plurality of display devices, relative positions of the vehicle and the plurality of drawings on the plurality of display targets; and
(b) outputting, to the plurality of display devices, the plurality of drawings generated in (a).
